(19) United States
(12) Patent Application Publication
(10) Pub. No.: US 2006/0078239 A1
(43) Pub. Date: Apr. 13, 2006

(54) Wave bearings in high performance applications

(76) Inventor: Florin Dimofte, Fairview Park, OH (US)

Correspondence Address: Florin Dimofte, 19871 Saranac Drive, Fairview Park, OH, 44126, US

(21) Appl. No.: 10/930,609

(22) Filed: Sep. 1, 2004

(51) Int. Cl. F16C 32/06

(52) U.S. Cl. 384/100

(57) ABSTRACT

The present disclosure concerns the application of the “Wave Bearing Concept” to journal and thrust fluid film bearings to increase performance and reliability. The wave surface is present on whichever member is stationary or non-rotating. Some applications are: pressurized gas journal wave bearings for increased load capacity and dynamic stability; journal wave bearings with liquid lubricants for extreme load capacity and excellent thermal and dynamic stability under any load; thrust wave bearings for axial positioning and axial loads; journal bearings with an elastic wave sleeve that can be activated via actuators (“active/passive control fluid film bearing”) or may change by itself (“smart bearings”) to adapt the bearing performance to the applied bearing load and speed. Journal and thrust bearings incorporating the present invention are appropriate for either mono-directional or bi-directional rotation.

### REFERENCES

1. Dimofte, F., “Wave Journal Bearing with Compressible Lubricant; Part I: The Wave Bearing Concept and a Comparison to the Plain Circular Bearing,” STLE Tribology Trans. Vol. 38, 1, pp.153-160, (1995).

U.S. Patent Documents:

| | | |
|---|---|---|
| 5,593,230 | Jan. 14, 1997 | Tempest, Michael, C., and Dimofte, Florin |
| 6,024,493 | Feb. 15, 2000 | Tempest, Michael, C., and Dimofte, Florin |
| 6,428,211 | Aug. 06, 2002 | Murabe, et al. |
| 6,402,385 | Jun. 11, 2002 | Hayakawa, et al. |

Statement of Federal Sponsored Research/Development:

Federal founds were use in certain testing of the wave bearings.

### BACKGROUND OF THE INVENTION

1. Field of the Invention

The present invention concerns journal and thrust fluid film bearings which include a wave surface to optimize load capacity, thermal stability, and dynamic behavior for varying operating conditions.

2. Description of Related Art

High speed, high performance machines need stable, low friction bearings in order to operate smoothly and efficiently. Current standard journal bearings suffer from instabilities that can severely hinder operation of such machinery.

The electronics industry has provided numerous new developments for high speed bearings, used, for example, in hard disc drives, laser printers, and other electronic equipment where speeds in excess of 10,000 rpm are needed. These bearings typically use a gas, specifically air, as a lubricant.

Tempest and Dimofte in U.S. Pat. No. 5,593,230 disclose an air bearing having a non-circular form, which when developed into a normally flat plane has a shallow sinusoidal contour having three peaks, “wave peaks.” Each peak is arranged 120° to an adjacent peak. The top peak is formed with a groove which enhances dynamic stability of the bearing.

Tempest and Dimofte in U.S. Pat. No. 6,024,493 disclose an air bearing which includes a static shaft wherein the shaft has a sinusoidal wave form, and a rotary polygon mirror device incorporating the air bearing.

Murabe and Komura in U.S. Pat. No. 6,428,211 disclose a hydrodynamic gas bearing structure comprising a shaft with notches, “space enlarging portions,” located about the circumference of the shaft at equal distances. These notches are used to supply fluid to the bearing.

Hayakawa, et al., in U. S. Pat. No. 6,402,385 disclose a dynamic pressure bearing that includes a rotary shaft and a centered oil-retaining bearing with pockets in the internal surface of the bearing to increase the pressure of the lubricating oil between the shaft and the oil-retaining bearing, for use in high rotational precision equipment, such as magnetic disc drives, polygon mirror rotary drives (laser printers), and the like.

Such bearings as described in the prior art have not been shown to perform in applications where high temperatures in addition to high speed may be encountered. In particular, gas turbine engine manufacturers are seeking engine main shaft bearings capable of operating up to temperatures of 700° F. and 4 million DN (where DN is the speed parameter, the product of bearing bore diameter in mm and shaft rotative speed in rpm). Such operating conditions are beyond the capability of conventional ball and roller bearings. Under even less severe conditions, ball and roller bearings become unreliable, with reduced life cycle, increased maintenance problems and costs, and increased safety concerns.

Conventional circular journal bearings are disadvantaged in high performance applications due to tendencies to promote shaft instabilities at high speeds and low load conditions. More recently, non-circular types of journal bearings which provide more stability have been developed; some are disclosed, for example, in U.S. Pat. Nos. 5,593,230; 6,024,493; and 6,428,211.

Gas lubricated journal wave bearings without any supply of lubricant are disclosed and have been described, in Dimofte, F., “Wave Journal Bearing with Compressible Lubricant-Part I: The Wave Bearing Concept and a Comparison to the Plain Circular Bearing,” STLE Tribology Transactions, Vol. 38(1), pp. 153-160 (1995).

The journal wave bearing is a journal bearing which features a non-circular or wave configuration on the bearing sleeve. (Ref. 1) There is a slight, but precise variation in the circular profile such that a wave profile is circumscribed on the diameter of the stationary part, having an amplitude equal to a fraction of the bearing clearance. The rotating member has a circular configuration. FIG. 1 shows a journal wave bearing having three waves in the bearing sleeve, and a circular rotating journal or shaft. The “radial clearance” is the difference between the sleeve and shaft radii. The sleeve radius is the radius of the mean circle of the wave (FIG. 1). The shaft can rotate in either direction. The waves have a starting point (FIG. 1) which is the maximum outside point of the wave profile closest to the load position, and can be located by the wave position angle. In FIG. 1 the wave height and clearance are greatly exaggerated. Typically, the wave height and the clearance are about one thousandth the size of the radius.

The journal wave bearing has several unique advantages when compared to either the plain journal bearing or other types of non-circular journal bearings such as a lobed, fixed pad, or tilting pad. The plain journal bearing has the highest load capacity, but shafts supported in it are subject to instabilities known as fractional frequency, whirl which can lead to failures. The occurrence of fractional frequency whirl makes journal plain bearings unsuitable for lightly loaded, high speed applications. Non-circular types of journal bearings can provide stable shaft operation and their use is obligatory in applications where “shaft whirl” is a problem. The journal wave bearing has two advantages over other known types of non-circular journal bearings: it has the highest load capacity of all the types of non-circular journal bearings, and it is the least expensive bearing to fabricate.

Journal wave bearing technology has been demonstrated with compressible fluid (gas) lubrication. With gas lubrication, the bearing is typically surrounded by the gas so that supplying the bearing with lubricant is not a problem; it does not require any sophisticated design features. The surrounding gas at the bearing edges is absorbed into the bearing where the distance between the shaft and the sleeve is large and it is exhausted where the shaft and sleeve surfaces are very close to each other.

There remained a need: to combine the wave shape advantages to raise the performance of the pressurized gas journal bearings; to extend the performance of the liquid lubricated journal bearings beyond their current limits by including the wave shape; to develop new, simple, and efficient thrust bearings that use the wave shape; and to open another avenue for developing active control and smart bearings based on wave bearing technology. All these create methods of operating high performance rotating machinery at higher speeds, higher temperatures, and higher efficiency, with extremely precise rotation and reliable performance. The present invention meets this need.

### SUMMARY

The object of this invention is to provide bearings having a wave surface on the stationary bearing part while the rotating member has a plain configuration. In particular the present invention provides a pressurized gas journal bearing having a wave surface that adds an improved hydrodynamic effect when the shaft rotates, in conjunction with the pressure supplied externally. The shaft can rotate in both directions. The bearing load capacity, stiffness, and stability can be significantly improved as compared to either a pressurized plain bearing or an aerodynamic wave bearing. The present invention also provides a liquid lubricated journal wave bearing having a wave surface circumscribed on the diameter of the stationary part. The position of the waves and the lubricant supply ports position is optimized for the specific application. Any liquid, such as, for example, cryogenics, mineral and synthetic hydrocarbon oils, fuels, water, polyphenylethers (PPE), and perfluoropolyethers (PFPE), can be used. The bearing can run at any temperature at which the lubricant remains stable. Another object of the present invention is to provide a bidirectional double thrust wave bearing consisting of an axial disk located between a pair of thrust plates. In addition, the present invention provides a mono-directional singular thrust wave bearing consisting of an axial disk that faces a thrust plate. Either the disk or the thrust plate rotates. The stationary part of this bearing (either the thrust plate or the disk) has a wave surface incorporated into its active face. The interaction of the stationary wave surface and the plain running surface generates hydrodynamic pressures that allow the bearing to carry thrust loads. These thrust wave bearings can be lubricated with any gas or liquid and can run at any temperature (assuming lubricant stability). Finally, this invention provides wave bearings with an elastic stationary part. The elastic part has a wave surface that can be distorted to adapt the bearing performance to the applied loads and speeds. The distortions are made by actuators (as an “Active/Passive Control Fluid Film Bearing”) or by the hydrodynamic pressures between the stationary and rotating parts (as a “Smart Bearing”).

### BRIEF DESCRIPTION OF THE FIGURES

FIG. 1 shows the journal wave bearing concept. Wave height and clearance are greatly exaggerated.

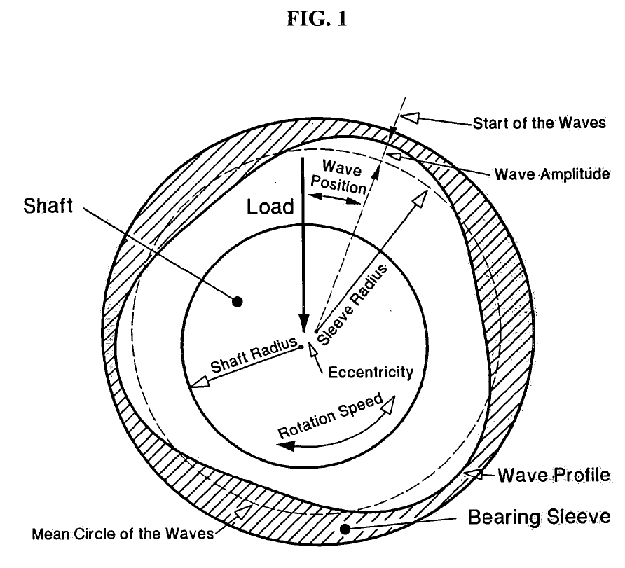

FIG. 2 shows a pressurized, gas lubricated wave bearing according to the present invention.

FIG. 2A shows a 3D view of the pressurized, gas lubricated, wave bearing sleeve according to the present invention.

FIG. 3 shows a liquid lubricated journal wave bearing according to the present invention.

FIG. 3A shows a 3D view of the liquid lubricated journal wave bearing sleeve according to the present invention.

FIG. 3B shows a pressure distribution in the fluid film of the liquid lubricated journal wave bearing according to the present invention.

FIG. 3C shows the profile of a transmission gear which acts as the bearing sleeve, distorted by the applied forces, and a stationary wave shaft, according to the present invention.

FIG. 4 shows a double thrust wave bearing according to the present invention.

FIG. 4A shows a 3D view of a thrust plate according to the present invention.

FIG. 4B shows a 3D view of a thrust plate with holes for pressurized gas according to the present invention.

FIG. 4C shows a 3D view of a thrust plate of a liquid lubricated thrust bearing according to the present invention.

FIG. 5 shows a journal wave bearing with an elastic sleeve that is distorted by actuators according to the present invention.

FIG. 5A shows a one wave elastic element according to the present invention.

FIG. 6 shows a bidirectional smart journal bearing with an elastic wave surface according to the present invention.

FIG. 6A shows an unloaded smart journal wave bearing according to the present invention.

FIG. 6B shows a smart journal wave bearing under half the maximum load, according to the present invention.

FIG. 6C shows a smart journal wave bearing under the maximum load, according to the present invention.

### DESCRIPTION OF THE PREFERRED EMBODIMENT

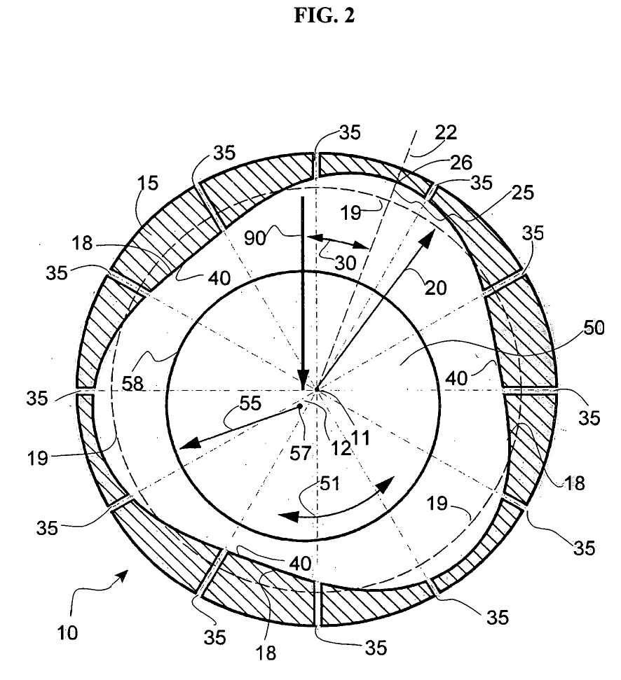

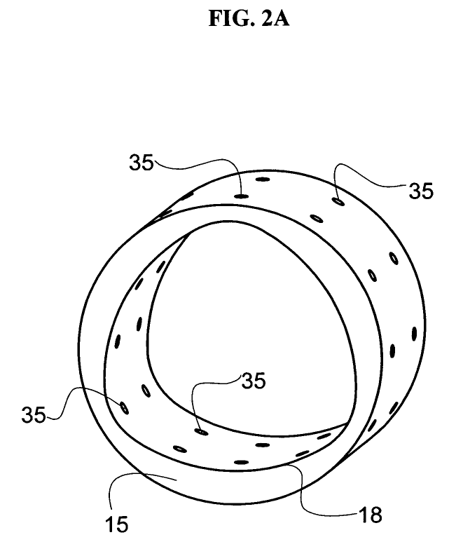

A pressurized gas journal wave bearing 10 according to the present invention is illustrated in FIG. 2. The journal bearing 10 supports a rotating shaft 50. A vertical load 90 is applied to the shaft 50.

The bearing sleeve 15 has a wave surface 18 circumscribed on its inner diameter. If the shaft is stationary and the sleeve is rotating, the wave profile is circumscribed on the shaft diameter (not illustrated). The profile of the wave surface 18 shows a “mean circle” 19. The radius 20 of the mean circle 19 is also the radius of the bearing sleeve. The wave surface has a starting point 22. The wave has an amplitude 25 which is the distance from the mean circle 19 to the maximum outside point of the wave 26. The position of the wave relative to the applied load direction 90 is defined by the wave position angle 30. The wave surface has a plurality of waves (three are illustrated here). The wave surface 18 is made either through a manufacturing process (such as grinding, lapping, honing, pressing, etc) or through elastic deformation of the sleeve 15 when it is mounted in its housing.

The bearing is supplied with gas (air) through holes 35 which can be designed with either inherent or orifice restrictors. In FIG. 2A, a 3D illustration of the bearing sleeve 15 is shown. Any number of supply holes 35 can be used (24 are illustrated). The holes 35 can be located in several supply planes (only two are illustrated in FIG. 2A).

The shaft has a radius 55 and an axis of rotation 57. Without a load, the axis of rotation 57 will be in the center of the bearing sleeve 11. When a load 90 is applied, the shaft axis 57 moves in an offset position. The distance 12 between the center of the sleeve 11 and the axis of the shaft 57 is the “eccentricity.” The difference between the bearing sleeve radius 20 and the shaft radius 55 is the bearing radial clearance. The ratio of the wave amplitude 25 to the radial clearance is the “wave amplitude ratio.”

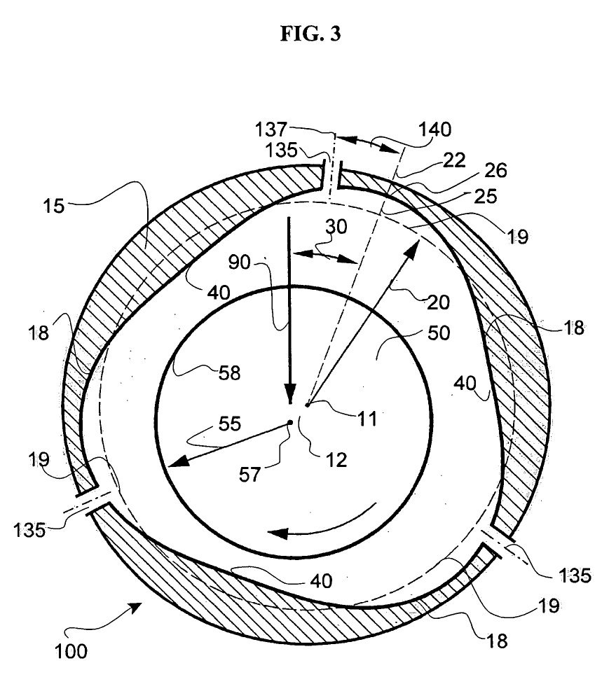

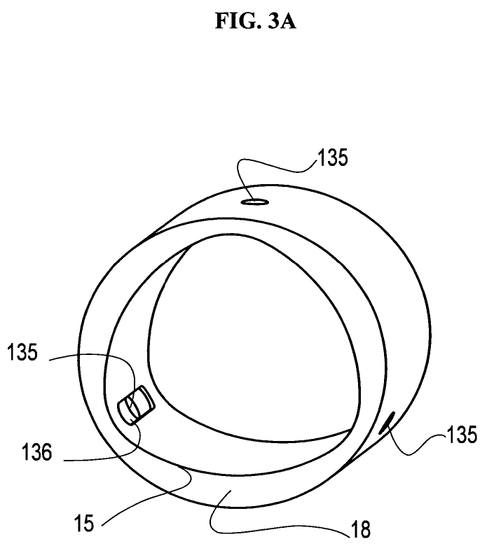

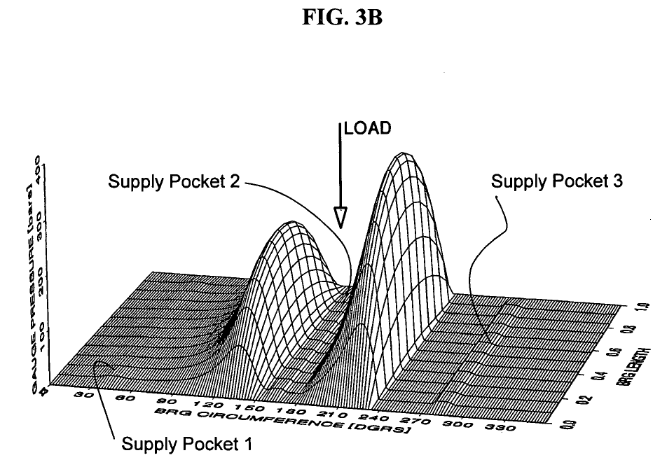

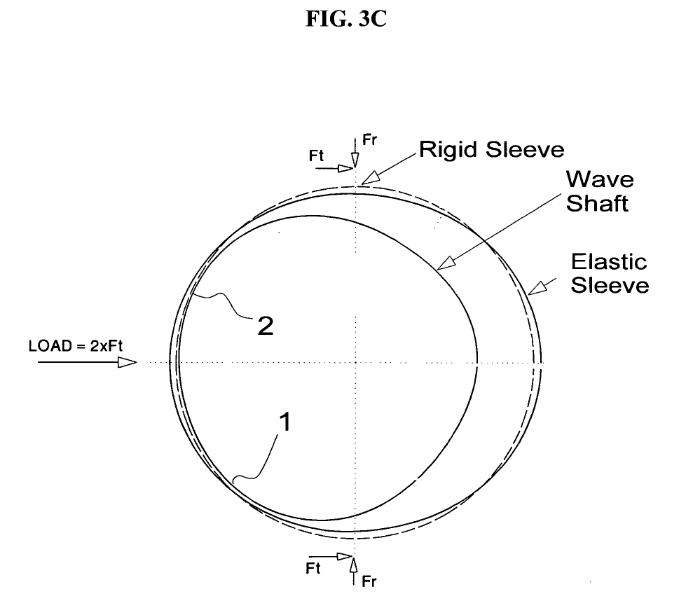

In most machinery, loads are built up as the shaft is rotating. At rest the load applied to the bearings is the weight of the rotating part only. Therefore, the gas (air) supplied through the holes 35 is enough to levitate a “non rotating” shaft 50. When the shaft starts rotating the pressure around the shaft is amplified by the hydrodynamic effect of the plurality of convergent regions of the fluid film thickness between the shaft surface 58 and the wave surface 18. According to the present invention, in FIG. 3, the fluid film between the shaft surface 58 and the wave surface 18 shows minimum thickness in several locations 40 (three here). Convergent regions of the fluid film are developed upstream of these locations 40 when the shaft rotates either clockwise or counterclockwise 51. These convergent regions help create hydrodynamic pressures, that in conjunction with the supplied pressurized gas increases the bearing load capacity beyond the limits of the load capacity of the hydrodynamic plain and wave bearing, or the pressurized plain bearing. The waves also improve the bearing stability. The bearing dynamic stiffness and damping can be adjusted to the values required in conjunction with the dynamic behavior of the rotor that is to be supported, by varying the wave amplitude 25. Thus, the rotor's critical speeds can be avoided and greater dynamic amplitude suppressed when the rotor runs at specific rotation speeds.

The sleeve 18 and the shaft 50 are made from: solid ceramic materials such as silicon nitride or silicon carbide; solid hard alloys with superficial coatings (such as physical vapor deposition, PVD, or diamond like carbon, DLC, coatings); or metallic materials with plasma spray ceramic coatings.

The pressurized wave bearing can be used (for example) in any high precision machinery, such as high precision tools, centrifuges, and inspection machines, as well as in small or medium sized turbo-machinery, compressors, fans, air-breathing machines, and auxiliary power units.

A journal wave bearing lubricated with liquids 10 according to the present invention, is illustrated in FIG. 3. The journal bearing 10 supports a rotating shaft 50. A vertical load 90 is applied to the shaft 50.

The bearing sleeve 15 has a wave 18 circumscribed on its inner surface. If the shaft is stationary and the sleeve rotates the wave surface is circumscribed instead on the shaft (not illustrated). The profile of the wave surface 18 shows a mean circle 19. The radius 20 of the mean circle 19 is also the radius of the bearing sleeve. The wave surface has a starting point 22. The wave has an amplitude 25 which is the distance from the mean circle 19 to the maximum outside point of the wave profile 26. The position of the wave surface relative to the applied load direction 90 is defined by the wave position angle 30. The value for this position angle 30 is optimize for the specific application and can be in a range from 0 to 60 degrees. The wave surface has a plurality of waves (three, for example, are illustrated). The wave surface 18 is produced either through a manufacturing process (such as grinding, lapping, honing, pressing, etc) or through elastic deformation of the sleeve 15 when it is mounted in its housing.

The bearing is supplied with a liquid lubricant through a plurality of holes 135 (only three are illustrated), one for each wave. These holes 135 feed the supply pockets with lubricant 136, as seen in FIG. 3A. In FIG. 3A, a 3D illustration of the bearing sleeve 15 is shown. The locations of the holes 135 and the pockets 136 relating to the wave profile 18 are defined by the “supply location angle” 140 between the supply hole axis 137 and the starting point of the waves 22. If this angle is zero (not illustrated in FIG. 3) the shaft can rotate in either a clockwise or a counterclockwise direction and the bearing is appropriate for bi-directional journal rotation. According to the present invention, the location of the holes 135 and the pockets 136 defined by the angle 140 can be optimized to maximize bearing load capacity while running at the lowest temperature. A frequent value is 20 degrees but can have various values for a specific application. In this case the journal bearing is appropriate for mono-directional rotation.

The shaft has a radius 55 and an axis of rotation 57. Without a load the axis of rotation 57 will be in the center of the bearing sleeve 11. When a load 90 is applied, the shaft axis 57 moves to an offset position. The distance 12 between the center of the sleeve 11 and the axis of the shaft 57 is the eccentricity. The difference between the bearing sleeve radius 20 and the shaft radius 55 is the bearing radial clearance. The ratio of the wave amplitude 25 to the radial clearance is the wave amplitude ratio.

When the shaft starts rotating, hills of pressure are created between the shaft 50 and the sleeve 15 due to the hydrodynamic effect of the plurality of convergent regions of the fluid film thickness between the shaft surface 58 and the wave profile 18. According to the present invention, in FIG. 3, the fluid film between the shaft surface 58 and the wave surface 18 shows minimum thicknesses in several locations 40 (three are illustrated). Convergent regions of the fluid film are upstream of all locations 40 when the shaft rotates either clockwise or counterclockwise 51. These convergent regions help create hydrodynamic pressures in any position of the shaft 50 inside the bearing sleeve 15. Thus, if the shaft 50 is unloaded and the eccentricity 12 is zero, the axis of the shaft 57 takes a concentric position in the center of the sleeve 11, and hills of pressure are still present—unlike the case of a plain journal bearing which cannot create any hydrodynamic pressure when it is unloaded. According to the present invention, the permanent presence of the hills of pressure inside the wave bearing as soon as the shaft rotates stabilizes the bearing at all loads. The wave position angle 30 can be selected so that the applied load to the bearing is supported by two hills of pressure. FIG. 3B shows the pressure distribution in an unwrapped bearing. The position of the load is in between two hills of pressure. A supply hole and pocket are inserted in between the pressure hills and fresh lubricant at supply temperature is injected into the bearing just before the next hill of high pressure. This configuration allows the bearing to run thermally stable at any load and temperature avoiding the situation of when the lubricant viscosity could collapses and bearing fails.

According to the present invention, wave journal bearings are appropriate for use when the rotating bearing part, either the bearing sleeve or the shaft, deforms under the applied load. A bearing with a rotating elastic sleeve is illustrated in FIG. 3C. Pressure distribution with multiple hills due to the wave profile (two are illustrated in FIG. 3B) with lubricant supply ports between the pressure hills supports deformation of the bearing sleeve. An example of such a case is a wave bearing used to support planetary gears in transmissions. In this case the shaft is stationary and the bearing sleeve, the actual planetary gear is rotating. Due to the gear loads the gear sleeve deforms and its shape varies from that of a rigid gear, as illustrated in FIG. 3C. The wave profile is circumscribed on the stationary shaft's outer diameter. The location of the waves are properly selected and the pressure hills, such as illustrated in FIG. 3B, support both radial Fr and tangential Ft loads shown in FIG. 3C. FIG. 3C also shows that an elastic gear sleeve supported by a waved shaft can handle heavy loads better than a rigid gear sleeve. The minimum lubricant film thickness of the elastic gear sleeve that occurs at position 1 is greater than the minimum film thickness of the rigid gear-sleeve that occurs at position 2. Thin film thicknesses such as at position 2 cause the bearing to fail.

To preserve the wave bearing performance, the bearing geometry must be unchanged during the wave bearing's life. The shaft and the sleeve is made from hard materials, with a hardness greater than 60 HRc. Any steels and alloys that can be hardened or case-hardened greater than 60 HRc may be used.

Coatings (such as physical vapor deposition, PVD, or diamond like carbon, DLC, coatings) are applied to both shaft and sleeve surfaces to avoid damage to the wave bearing surfaces when the bearing starts and stops, and to make the wave bearing less sensitive to lubricant interruption.

The wave bearing, according to the present invention, can be used in heavily loaded applications with specific loads up to 24 MPa (3500 PSI). The wave bearing is also very appropriate for use in any medium-sized loaded application with specific loads up to 5.5 MPa (800 PSI) where stable motion is requested at all loads. Journal wave bearings, according to the present invention, are appropriate for either mono-directional or bi-directional journal rotation. The wave bearings have stiffness and damping properties that can be adjusted to the needs of the machinery in which they are being used. In particular, their damping characteristics are useful to attenuate the noise and vibration level of any machinery and particularly in mechanical aero and terrestrial transmissions. Their thermal stability makes the wave bearings very suitable for high temperature application. When lubricated with polyphenylethers (PPE) and perfluoropolyethers (PFPE) the wave bearing runs at temperatures over 350° C. (662° F.).

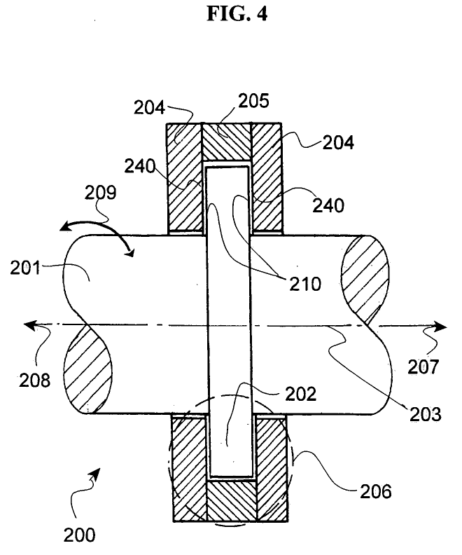

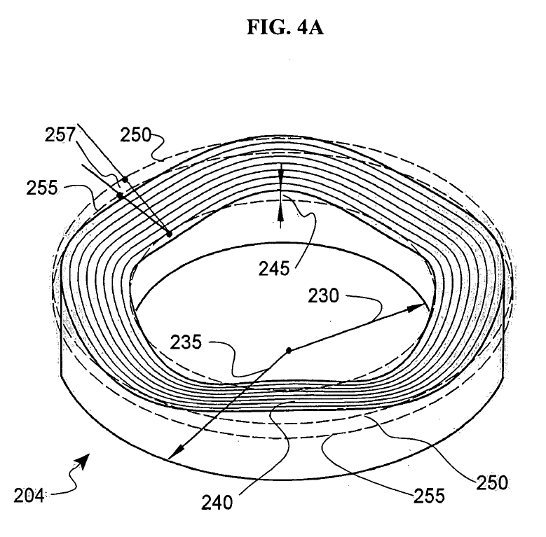

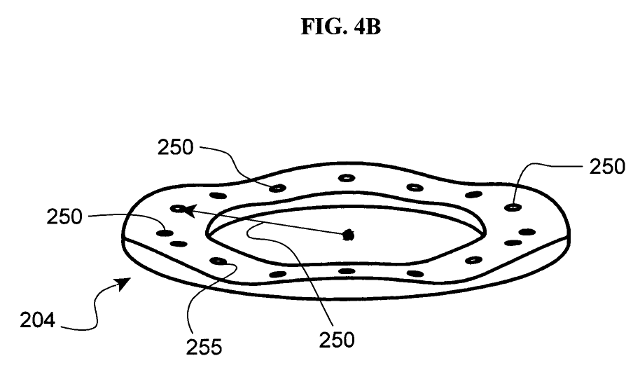

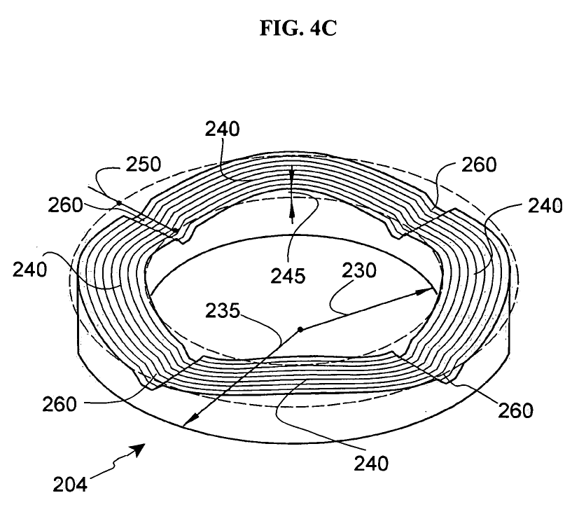

A bidirectional thrust wave bearing 200 lubricated with a fluid (gas or liquid) according to the present invention is illustrated in FIG. 4. A rotating shaft 201 having a disk 202 is supported in the axial direction 203 by two stationary thrust plates 204 separated by a spacer 205. The thrust plates provide a bidirectional axial effect in the region 206 that positions the shaft in the axial direction 203 or carries loads in both axial directions 207 and 208. If the axial load is permanent in only one direction and no axial positioning is required, only one thrust plate 204 is used for a mono-directional thrust wave bearing (not illustrated). The shaft rotates around its axis 203 either in clockwise or counterclockwise directions 209.

A thrust plate 204 is illustrated in FIG. 4A. According to the present invention, both gases and liquids can be used as lubricants. The thrust plate 204 has an inner radius 230 and an outer radius 235. The active face of the thrust plate 204 has a wave surface 240 with a “middle plane” 250. The middle plane 250 is tilted from the horizontal plane 255 with a tilt angle 257. The tilt angle is positive (as illustrated), or can be negative or zero. The wave surface 240 has a plurality of waves (four are illustrated). Each wave has an amplitude 245 which is constant along the radial direction as illustrated in FIG. 4A, or variable along the radial direction (not illustrated). The active wave surface 240 of the thrust plate 204 faces the disc's active surface 210. If the shaft is stationary and the thrust plate(s) 204 rotate, the wave surface is made on the disc's active surface 210. The wave surface 240 or 210 is produced either through a manufacturing process (such as grinding, lapping, honing, pressing, etc) or through elastic deformation of the thrust plate 204 when it is mounted in his housing.

According to the present invention, a gas thrust wave bearing could be also supplied with pressurized gas through holes with restrictors as illustrated in FIG. 4B. The holes 250 are located at a radius 255 greater than inner radius 230 and less than outer radius 235. The pressurized gas provides a smooth start. In addition, according to the present invention, when the shaft rotates the pressurized gas is supplied through holes 250 into the clearance between the active surface 210 of the disk 202 and the active surface 240 of the thrust plate 204; in conjunction with this, the hydrodynamic effect of the wave surface 240 increases the bearing performance beyond the limits of either the pressurized thrust bearing with plain surfaces or a non-pressurized thrust wave bearing.

When a liquid lubricant is used, according to the present invention, the thrust plates 204 could have radial grooves 260 at the start of each wave, as illustrated if FIG. 4C. These radial grooves allow the lubricant to easily enter between the active surface 210 of the disk 202 and the active surface 240 of the thrust plate 204. The liquid lubricant can also supply the thrust bearing through holes and pockets similar to the holes 135 and pockets 136 illustrated in FIG. 3A. These holes and pockets are located at the start of each wave, replacing the grooves 260. The wave surface 240 has the middle plane 250 horizontal with a zero tilt angle and the wave amplitude 245 is constant along the radius. The wave amplitude 245 can vary along the radius (not illustrated in FIG. 4C). Positive or negative tilt angle 257 can be also used but not illustrated in FIG. 4C.

According to the present invention, both the disk 206 and the thrust plates 204 are made from hard materials. For gas lubricated thrust bearings the disk and the thrust plate are made from: solid ceramic materials such silicon nitride or silicon carbide; solid hard alloys with a superficial coating (such as physical vapor deposition, PVD, or diamond like carbon, DLC coatings) on the active faces 210 and 240; or hard stainless steels with plasma spray ceramic coatings on the active faces 210 and 240. For liquid lubricated thrust bearings, steels and alloys that can be hardened or case-hardened over 60 HRc can be used. Coatings (such as physical vapor deposition, PVD, or diamond like carbon, DLC, coatings) are applied on the active faces 210 and 240 to avoid damage to the bearing surfaces when the bearing starts and stops and to make the bearing less sensitive to lubricant interruption.

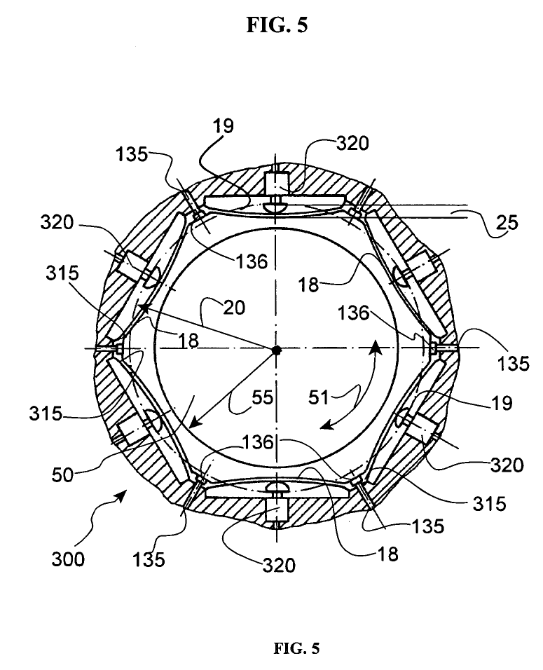

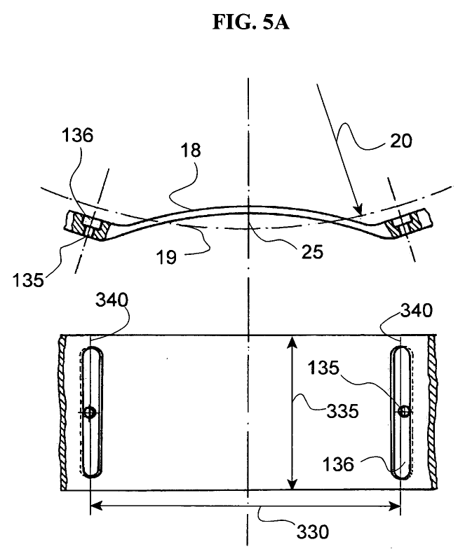

A controllable journal wave bearing 300, according to the present invention, is illustrated in FIG. 5. The controllable journal wave bearing 300 supports a rotating shaft 50. The shaft 50 can rotate clockwise or counterclockwise 51. The bearing housing 310 includes an elastic shell 315 that has a wave surface 18 with a mean radius 20 and amplitude 25. The wave surface has a plurality of waves (six are illustrated). A portion of the elastic shell 315 that corresponds to one wave is illustrated in FIG. 5A. This portion has a length 330 (called L) and a width 335 (called B). The ratio of B/L should be close to 1/2. The mean radius of the waves 20 is called Rₘ. The number of waves is approximated as 2πRₘ/L, but is not less than three. Large diameter bearings with a length to diameter ratio of less than 1/2 need more than 3 waves. The elastic shell 315 is made as one piece or from a number of pieces, one for each wave. They are assembled together at the locations of wave ends.

According to the present invention, the amplitude 25 of the wave is controlled by the actuators 320. Any type of actuator can be used, for example, mechanical, electromagnetic, piezoelectric, hydraulic, or pneumatic. The actuators are connected to an active or passive control system that adjusts the wave amplitude 25 to shaft speed, shaft vibration level, and load. Enlarging the wave amplitude 25 causes the bearing to run stably and increases the bearing stiffness. Under heavy loads the bearing is stable and the wave amplitude should be diminished to approach the plain journal bearing geometry; the bearing can then carry a heavy load better than any type of fluid film bearing.

The bearing 300 is lubricated with a liquid lubricant. Both oils and fuels are can be used. The lubricant is supplied to the bearing through holes 135 and pockets 136 shown in FIG. 5 and FIG. 5A. The holes and pockets are located at the beginning of each wave. According to the present invention, this location of the pressure holes and pockets permits a supply of fresh lubricant near the hot spots of the fluid film which keeps the bearing running thermally stable, especially at high speeds or heavy loads.

Both the shaft 50 and the elastic shell 315 are made from hard materials, with hardness over 60 HRc. Any steels and alloys that can be hardened or case-hardened over 60 HRc can be used. Coatings (such as physical vapor deposition, PVD, or diamond like carbon, DLC, coatings) are applied to both shaft and elastic shell surfaces to avoid damage to the controllable bearing surfaces when the bearing starts and stops, and to make the controllable bearing less sensitive to lubricant interruption.

According to the present invention, the controllable bearing 300 can be used in high performance rotating machinery which needs high precision rotation, or safe rotation with levels of vibration under fixed limits. Rotating machinery which is heavily loaded but starts and stops under low loads will benefit from the use of the controllable wave bearing 300.

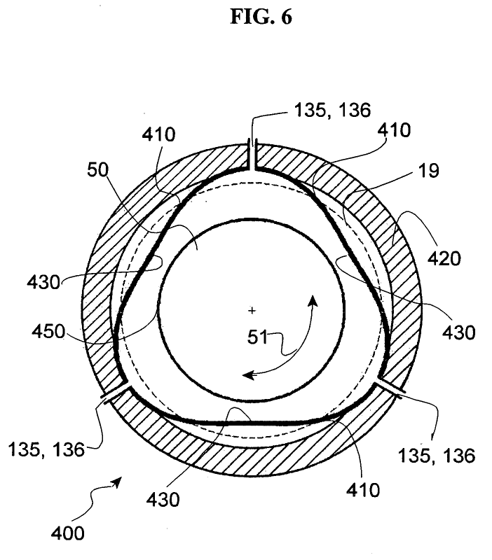

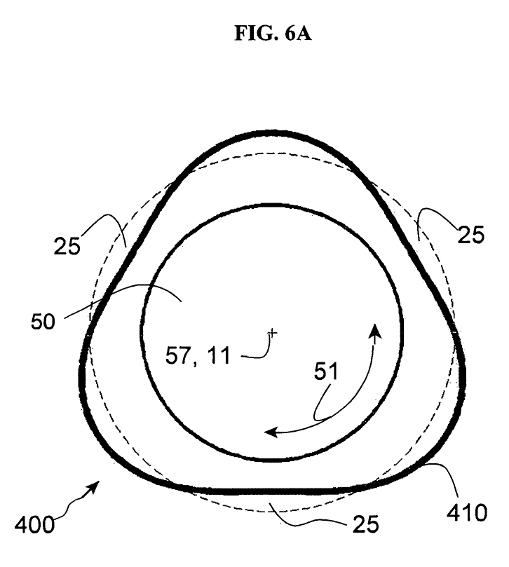

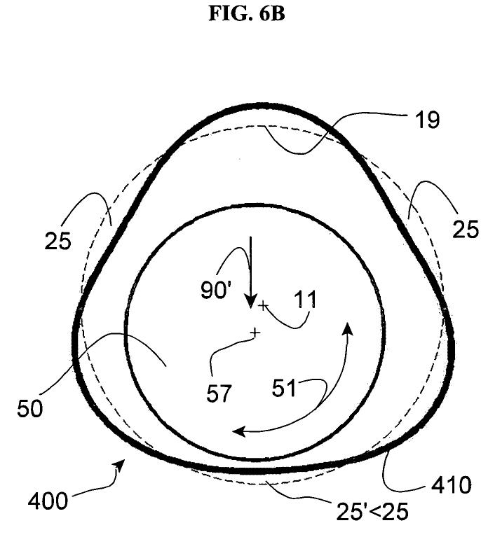

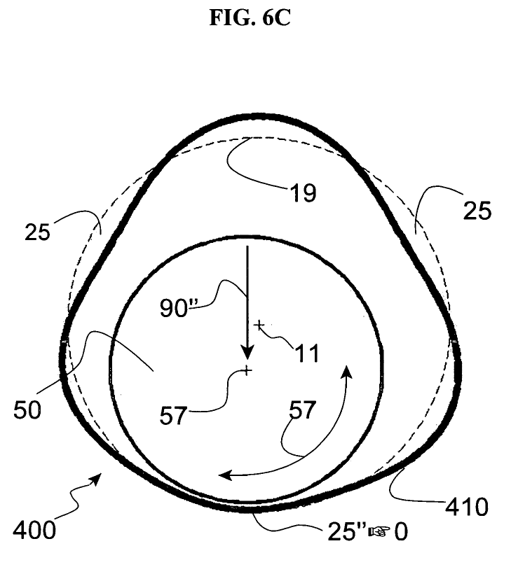

According to the present invention, a self-acting (smart) wave bearing 400 is illustrated in FIG. 6. The smart wave bearing 400 supports a rotating shaft 50. The shaft 50 rotates clockwise or counterclockwise 51. The smart wave bearing has an elastic shell 410. The elastic shell has initial shape as a wave surface with a mean circle 19. The wave surface has a plurality of waves (three are illustrated). The elastic shell 410 is supported by the bearing housing 420. If the bearing is lubricated with a liquid, holes 135 and pockets 136 are located at the beginning of each wave. The shell is free to deform under the pressure in the fluid film and to change the position of its inside sections 430 that are closer to the shaft surface 450 than the mean circle 19. FIGS. 6A to 6C show haw the smart bearing works. If the shaft 50 rotates and is unloaded (FIG. 6A), its axis 57 is concentric to the shell center 11. The shell wave surface is uniform around the circumference and has equal amplitudes 25 in all locations. According to the present invention, the shaft is running stably due to the wave shape of the shell when it is unloaded.

If a vertical load is applied to the shaft, the pressure in the fluid film opposite the load increases and distorts the shape of the elastic shell in that region. FIG. 6B illustrates a case when a vertical load 90′, equal to one half of the maximum load that the bearing can carry, is applied to the shaft 50. According to the present invention, when the load 90′ is applied, the axis 57 of the shaft moves into an eccentric position relative to the center 11 of the elastic shell; the pressure increases in the bottom side of the shaft, and the elastic shell 410 diminishes its amplitude 25′ at the bottom of the bearing (compared to the initial amplitude 25 of the wave surface). This makes the bearing better able to carry the applied load 90′, while still running stably, due to the wave shape of the elastic sleeve 410 (FIG. 6B) which still shows a three wave shape.

According to the present invention, if the vertical load increases to the maximum load 90″ that the smart bearing 400 can carry, the amplitude 25″ of the bottom wave goes to zero, approaching a shape similar to that of a plain bearing on the bottom side, as illustrated in FIG. 6C. The elastic shell 410 superimposed over the mean circle in the bottom side of the smart bearing allows the bearing to carry a higher maximum load than a rigid wave bearing.

According to the present invention, any fluid (gas or liquid) can be used to lubricate the smart bearing. The smart bearing runs very stably dynamically and thermally at any speeds and loads and can carry a maximum load greater than any fluid film bearing including a plain journal bearing. The mart bearing can approach a shape similar to the plain bearing in the region that carries the load as the load increases (see FIGS. 6A to 6C), but it is better lubricated than the plain bearing, running more thermally stable than the plain bearing.

Both the elastic shell and the shaft are from a hard metallic alloy. Coatings (such as physical vapor deposition, PVD, or diamond like carbon, DLC, coatings) are applied to both shaft and elastic shell surfaces to avoid damage to the controllable bearing surfaces when the bearing starts and stops, and to make the smart bearing less sensitive to lubricant interruption.

1. A fluid film bearing with a wave surface on its stationary member that supports a plain rotating member, said wave bearing comprising:
a. a plurality of waves on said wave surface.
b. a plurality of ports to supply the bearing with fluid lubricant.

2. The wave bearing as described in claim 1 further comprising a rigid stationary sleeve with said wave surface, which circumscribes a circular shaft, as a journal wave bearing.

3. The journal wave bearing as described in claim 2 further comprising holes with restrictors to supply the bearing with pressurized gas.

4. The journal wave bearing as described in claim 3 further comprising the rotor and the sleeve made of hard ceramic material such as silicon nitride and silicon carbide.

5. The journal wave bearing as described in claim 3 further comprising the rotor and the sleeve made of hard metallic alloy coated with PVD or DLC coating.

6. The journal wave bearing as described in claim 3 further comprising the rotor and the sleeve from a metallic material with plasma spray coating.

7. The journal wave bearing as described in claim 2 further comprising holes and pockets to supply the bearing with liquid lubricant.

8. The journal wave bearing as described in claim 7 further comprising an optimal position of the holes and pockets for maximum load capacity and thermal stability.

9. The journal wave bearing as described in claim 7 further comprising the rotor and the sleeve made of a hard metallic alloy coated with PVD or DLC coating.

10. The journal wave bearing as described in claims 7, 8, and 9 further comprising the use of polyphenylethers (PPE) or perfluoropolyethers (PFPE) as a liquid lubricant to run at temperatures over 350° C. (662° F.).

11. The journal wave bearing as described in claims 7, 8, and 9 that has a stationary shaft and a rotating sleeve with an optimized position of the wave to maximize the load capacity, to minimize bearing temperature and to support the elastic sleeve distortion under load.

12. The journal wave bearing as described in claims 7, 8, and 9 or 11 that is used for noise and vibration attenuation in rotating machinery including mechanical transmissions.

13. The journal wave bearing as described in claim 1, with a wave surface that circumscribes a rigid stationary shaft.

14. The journal wave bearing as described in claim 13 further having holes and pockets to supply the bearing with liquid lubricant

15. The journal wave bearing as described in claim 13 further comprising an optimal position of the holes and pockets for maximum load capacity and thermal stability.

16. The journal wave bearing as described in claim 13 further comprising the rotor and the sleeve made of a hard metallic alloy coated with PVD or DLC coating.

17. The journal wave bearing as described in claims 13, 14, 15, and 16 further having an elastic gear-sleeve.

18. The journal wave bearing as described in 17 used for noise and vibration attenuation in rotating machinery including mechanical transmissions.

19. The wave bearing as describe in claim 1 further comprised of a wave surface on the face of its stationary part as a said thrust wave bearing. The thrust bearing can have one or two said thrust plates.

20. The thrust wave bearing as described in claim 19 further having holes with restrictors to supply the bearing with pressurized gas.

21. The thrust wave bearing as described in claim 19 further having radial grooves at the beginning of each wave when used with liquid lubricant.

22. The thrust wave bearing as described in claim 19 further having holes and pockets at the beginning of each wave to supply the bearing with liquid lubricant.

23. The thrust wave bearing as described in claim 19 further comprising the disk and the thrust plate(s) from hard metallic alloy coated with PVD or DLC coating.

24. The wave bearing as described in claim 1 further comprising a said elastic wave shell.

25. The wave bearing as described in claim 24 further comprising actuators to control the shape of its elastic wave shell as said active/passive controlled fluid film bearing.

26. The wave bearing as described in claim 24 further having holes and pockets to supply the bearing with liquid lubricant.

27. The wave bearing as described in claim 24 further comprising an elastic wave shell which deforms under bearing loads so that the bearing self-reacts to adapt to the running condition as said smart bearing.

28. The wave bearing as described in claim 27 further comprising holes and pockets to supply the bearing with liquid lubricant.

29. The wave bearing as described in claim 25 or 27 further comprising the rotor and the elastic wave shell made of hard metallic alloy coated with PVD or DLC coating.
